(19) United States
(12) Patent Application Publication
(10) Pub. No.: US 2004/0205297 A1
(43) Pub. Date: Oct. 14, 2004

(54) Method of cache collision avoidance in the presence of a periodic cache aging algorithm

(76) Inventor: Brian S. Bearden, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/414,180

(22) Filed: Apr. 14, 2003

(51) Int. Cl. G06F 12/08

(52) U.S. Cl. 711/133; 711/145

(57) ABSTRACT

Exemplary systems and methods employ cache management to efficiently manage cache usage in a storage device. An exemplary cache management module for cache management identifies old pages in write cache memory and assigns old pages to corresponding I/O resources for de-staging. If no I/O resources are available for de-staging the old pages, destage request(s) are put on a queue up to a threshold number of destage requests. Any old pages not assigned to I/O resources or having a corresponding destage request are made accessible for access in response to host I/O requests.

### CROSS REFERENCE TO RELATED APPLICATIONS

The present application contains subject matter related to the following co-pending applications: “Method of Detecting Sequential Workloads to Increase Host Read Throughput,” identified by HP Docket Number 100204483-1; “Method of Adaptive Read Cache Pre-Fetching to Increase Host Read Throughput,” identified by HP Docket Number 200207351-1; “Method of Adaptive Cache Partitioning to Increase Host I/O Performance, identified by HP Docket Number 200207897-1; and “Method of Triggering Read Cache Pre-Fetch to Increase Host Read Throughput,” identified by HP Docket Number 200207344-1. The foregoing applications are incorporated by reference herein, assigned to the same assignee as this application and filed on even date herewith.

### TECHNICAL FIELD

The present disclosure relates to storage devices, and more particularly, to data caching.

### BACKGROUND

Computer data storage devices, such as disk drives and Redundant Array of Independent Disks (RAID), typically use a cache memory in combination with mass storage media (e.g., magnetic tape or disk) to save and retrieve data in response to requests from a host device. Cache memory, often referred to simply as “cache”, offers improved performance over implementations without cache. Cache typically includes one or more integrated circuit memory device(s), which provide a very high data rate in comparison to the data rate of non-cache mass storage medium. Due to unit cost and space considerations, cache memory is usually limited to a relatively small fraction of (e.g., 256 kilobytes in a single disk drive) mass storage medium capacity (e.g., 256 Gigabytes). As a result, the limited cache memory should be used as efficiently and effectively as possible.

Cache is typically used to temporarily store data that is the most likely to be requested by a host computer. By read pre-fetching (i.e., retrieving data from the host computer's mass storage media ahead of time) data before the data is requested, data rate may be improved. Cache is also used to temporarily store data from the host device that is destined for the mass storage medium. When the host device is saving data, the storage device saves the data in cache at the time the host computer requests a write. The storage device typically notifies the host that the data has been saved, even though the data has been stored in cache only; later, such as during an idle time, the storage device “destages” data from cache (i.e., moves the data from cache to mass storage media). Thus, cache is typically divided into a read cache portion and a write cache portion. Data in cache is typically processed on a page basis. The size of a page is generally fixed and is implementation specific; a typical page size is 64 kilobytes.

A problem that may occur with regard to de-staging is called cache collision. In general, a cache collision is an event in which more than one process is attempting to access a cache memory location simultaneously. A cache collision may occur when data is being destaged at the same time that a host computer is attempting to update that data. For example, if a storage device is in the process of de-staging a page of cache data to a sector on a disk in a RAID system, and the host device requests a data write to the same page, this event causes a cache collision because the host write request and the de-staging process address the same area in memory.

During a de-staging process, the data being destaged is locked, and cannot be changed by host write requests to ensure data integrity. If a cache collision occurs with respect to a locked page, the associated host request(s) are put on a queue to be handled when the de-staging process ends, and the page is unlocked. Thus, during a cache collision, the storage device typically must finish the de-staging process prior to responding to the host computer write request. As a result, a cache collision may cause unwanted delays when the host device is attempting to save data to disk. The length of a delay due to a cache collision depends on a number of parameters, such as the page size and where a host request arrives relative to de-staging. In some cases, a cache collision can result in a time-out of the host device.

Cache collisions may be particularly troublesome for implementations that use a periodic cache aging (PCA) algorithm. PCA algorithms are often used in storage devices to periodically determine the age of pages in cache memory. If a page is older than a set time, the page will be destaged. PCA algorithms are used to ensure data integrity in the event of power outage or some other catastrophic event. A PCA algorithm may run substantially periodically at a set aging time period to identify and destage cache pages that are older than the set aging time. The set aging time for any particular implementation is typically, to some extent, based on a best guess at the sorts of workloads the storage device will encounter from a host device. For example, in one known implementation, the set aging time is 4 seconds. While this periodic time may be based on experimental studies, in actuality, any particular workload may not abide by the assumptions implicit in the PCA algorithm, which may result in cache collisions.

Thus, although write caching generally improves data rate in a storage device, cache collisions can occur, causing delays and time-outs in data input/output (I/O).

### SUMMARY

It is with respect to the foregoing and other considerations, that various exemplary systems, devices and/or methods presented herein have been developed.

An exemplary method involves determining whether a cache page in a storage device is older than a predetermined age. If the cache page is older than the predetermined age, available input/output resource(s) may be used to destage the cache page. If no input/output resources are available and a destage request queue has fewer than a threshold number of destage requests, a destage request associated with the cache page may be put on the destage request queue.

An exemplary system includes a storage device having a cache management module that may assign input/output resources to an old page in cache memory. The cache management module may further queue a maximum number of destage requests corresponding to one or more of the old pages. The cache management module may allow an old cache page to be used to satisfy host write requests.

### BRIEF DESCRIPTION OF THE DRAWINGS

FIG. 1 illustrates a system environment that is suitable for managing cache in a storage device such that cache collisions are minimized.

FIG. 2 is a block diagram illustrating in greater detail, a particular implementation of a host computer device and a storage device as might be implemented in the system environment of FIG. 1.

FIG. 3 is a block diagram illustrating in greater detail, another implementation of a host computer device and a storage device as might be implemented in the system environment of FIG. 1.

FIG. 4 illustrates an exemplary functional block diagram that may reside in the system environments of FIGS. 1-3, wherein a cache management module communicates with a resource allocation module in order to manage de-staging of write cache pages.

FIG. 5 illustrates an operational flow having exemplary operations that may be executed in the systems of FIGS. 1-4 for managing cache such that cache collisions are minimized.

FIG. 6 illustrates an operational flow having exemplary operations that may be executed in the systems of FIGS. 1-4 for managing cache such that cache collisions are minimized.

### DETAILED DESCRIPTION

Various exemplary systems, devices and methods are described herein, which employ a cache management module for managing read and write cache memory in a storage device. Generally, the cache management module employs operations to destage old write cache pages, whereby a cache collision may be substantially avoided. More specifically, an exemplary cache management module uses available input/output (I/O) resource(s) to destage write cache pages. Still more specifically, if no I/O resource(s) are available, de-staging requests are created for additional cache pages that should be destaged. More specifically still, a queuing operation involves queuing up to a threshold number of de-staging requests associated with write cache pages to be destaged. More specifically still, any queued requests may be handled after one or more I/O resource(s) become available to handle the page de-staging jobs associated with de-staging request(s). Various exemplary methods employed by the systems described herein utilize limited I/O resources efficiently such that cache collisions are substantially avoided.

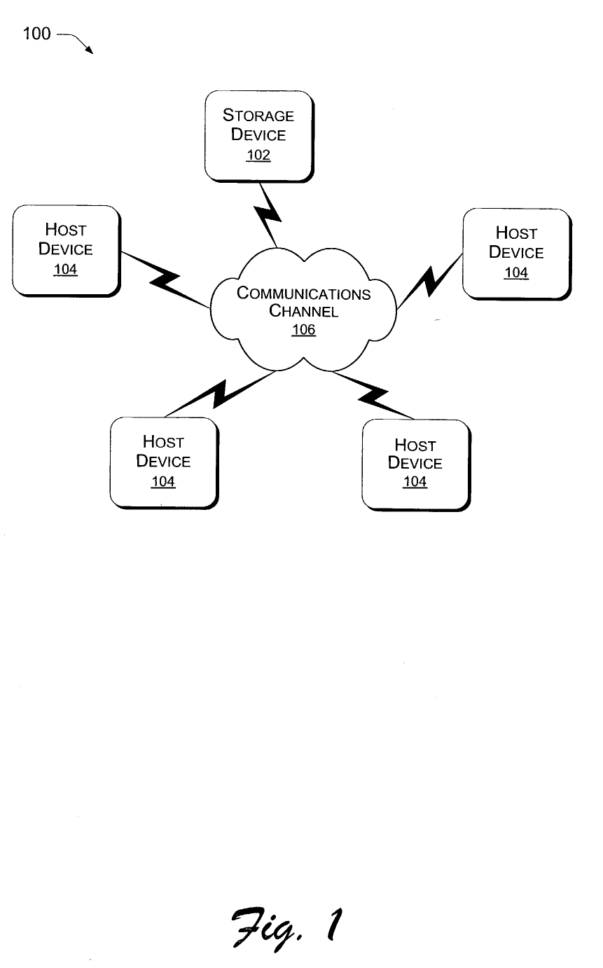

FIG. 1 illustrates a suitable system environment 100 for managing cache memory in a storage device 102 to efficiently utilize limited resources on the storage device to respond to data input/output (I/O) requests from one or more host devices 104. The storage device 102 may utilize cache memory in responding to request(s) from the one or more host devices 104. The efficient utilization of limited resources facilitates such substantial avoidance of cache collisions in the storage device 102. By avoiding cache collisions, storage performance goals are more likely achieved than if cache collisions occur frequently.

Storage performance goals may include mass storage, low cost per stored megabyte, high input/output performance, and high data availability through redundancy and fault tolerance. The storage device 102 may be an individual storage system, such as a single hard disk drive, or the storage device 102 may be an arrayed storage system having more than one storage system. Thus, the storage devices 102 can include one or more storage components or devices operatively coupled within the storage device 102, such as magnetic disk drives, tape drives, optical read/write disk drives, solid state disks and the like.

The system environment 100 of FIG. 1 includes a storage device 102 operatively coupled to one or more host device(s) 104 through a communications channel 106. The communications channel 106 can be wired or wireless and can include, for example, a LAN (local area network), a WAN (wide area network), an intranet, the Internet, an extranet, a fiber optic cable link, a direct connection, or any other suitable communication link. Host device(s) 104 can be implemented as a variety of general purpose computing devices including, for example, a personal computer (PC), a laptop computer, a server, a Web server, and other devices configured to communicate with the storage device 102.

Various exemplary systems and/or methods disclosed herein may apply to various types of storage devices 102 that employ a range of storage components as generally discussed above. In addition, storage devices 102 as disclosed herein may be virtual storage array devices that include a virtual memory storage feature. Thus, the storage devices 102 presently disclosed may provide a layer of address mapping indirection between host 104 addresses and the actual physical addresses where host 104 data is stored within the storage device 102. Address mapping indirection may use pointers or other dereferencing, which make it possible to move data around to different physical locations within the storage device 102 in a way that is transparent to the host 104.

As an example, a host device 104 may store data at host address H₅, which the host 104 may assume is pointing to the physical location of sector #56 on disk #2 on the storage device 102. However, the storage device 102 may move the host data to an entirely different physical location (e.g., disk #9, sector #27) within the storage device 102 and update a pointer (i.e., layer of address indirection) so that it always points to the host data. The host 104 may continue accessing the data using the same host address H₅, without having to know that the data has actually resides at a different physical location within the storage device 102.

In addition, the storage device 102 may utilize cache memory to facilitate rapid execution of read and write operations. When the host device 104 accesses data using a host address (e.g., H₅), the storage device may access the data in cache, rather than on mass storage media (e.g., disk or tape). Thus, the host 104 is not necessarily aware that data read from the storage device 102 may actually come from a read cache or data sent to the storage device 102 may actually be stored temporarily in a write cache. When data is stored temporarily in write cache, the storage device 102 may notify the host device 104 that the data has been saved, and later destage, or write the data from the write cache onto mass storage media.

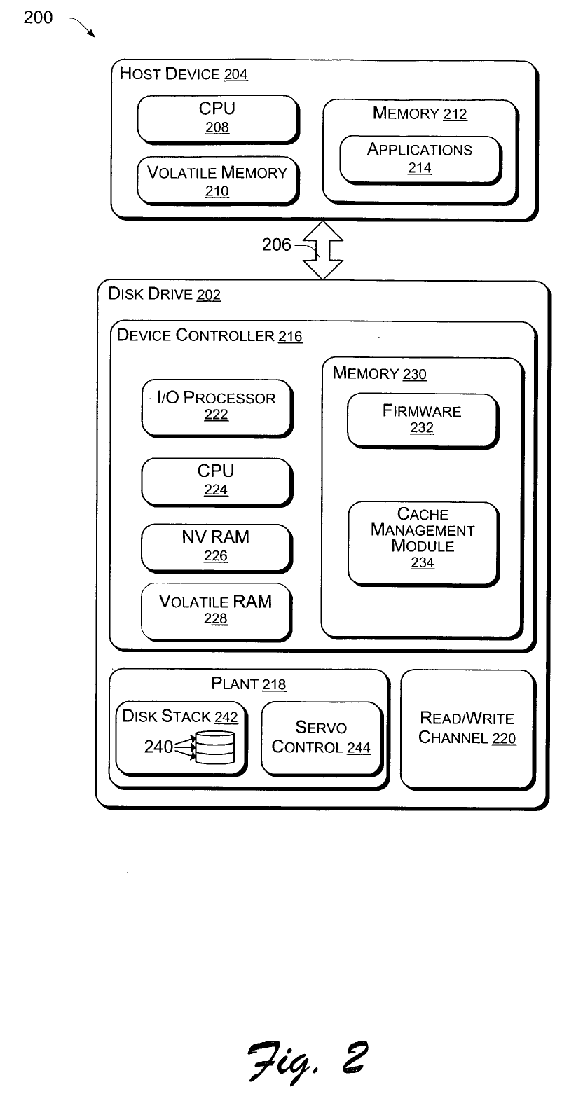

FIG. 2 is a functional block diagram illustrating a particular implementation of a host computer device 204 and a storage device 202 as might be implemented in the system environment 100 of FIG. 1. The storage device 202 of FIG. 2 is embodied as a disk drive. While the cache management methods and systems are discussed in FIG. 2 with respect to a disk drive implementation, it will be understood by one skilled in the art that the cache management methods and systems may be applied to other types of storage devices, such as tape drives, CD-ROM, and others. The host device 204 is embodied generally as a computer such as a personal computer (PC), a laptop computer, a server, a Web server, or other computer device configured to communicate with the storage device 202.

The host device 204 typically includes a processor 208, a volatile memory 210 (i.e., RAM), and a nonvolatile memory 212 (e.g., ROM, hard disk, floppy disk, CD-ROM, etc.). Nonvolatile memory 212 generally provides storage of computer readable instructions, data structures, program modules and other data for the host device 204. The host device 204 may implement various application programs 214 stored in memory 212 and executed on the processor 208 that create or otherwise access data to be transferred via a communications channel 206 to the disk drive 202 for storage and subsequent retrieval.

Such applications 214 might include software programs implementing, for example, word processors, spread sheets, browsers, multimedia players, illustrators, computer-aided design tools and the like. Thus, host device 204 provides a regular flow of data I/O requests to be serviced by the disk drive 202. The communications channel 206 may be any bus structure/protocol operable to support communications between a computer and a disk drive, including, Small Computer System Interface (SCSI), Extended Industry Standard Architecture (EISA), Peripheral Component Interconnect (PCI), Attachment Packet Interface (ATAPI), and the like.

The disk drive 202 is generally designed to provide data storage and data retrieval for computer devices such as the host device 204. The disk drive 202 may include a controller 216 that permits access to the disk drive 202. The controller 216 on the disk drive 202 is generally configured to interface with a disk drive plant 218 and a read/write channel 220 to access data on one or more disk(s) 240. Thus, the controller 216 performs tasks such as attaching validation tags (e.g., error correction codes (ECC)) to data before saving it to disk(s) 240 and checking the tags to ensure data from a disk(s) 240 is correct before sending it back to host device 104. The controller 216 may also employ error correction that involves recreating data that may otherwise be lost during failures.

The plant 218 is used herein to include a servo control module 244 and a disk stack 242. The disk stack 242 includes one or more disks 240 mounted on a spindle (not shown) that is rotated by a motor (not shown). An actuator arm (not shown) extends over and under top and bottom surfaces of the disk(s) 240, and carries read and write transducer heads (not shown), which are operable to read and write data from and to substantially concentric tracks (not shown) on the surfaces of the disk(s) 240.

The servo control module 244 is configured to generate signals that are communicated to a voice coil motor (VCM) that can rotate the actuator arm, thereby positioning the transducer heads over and under the disk surfaces. The servo control module 244 is generally part of a feedback control loop that substantially continuously monitors positioning of read/write transducer heads and adjusts the position as necessary. As such, the servo control module 244 typically includes filters and/or amplifiers operable to condition positioning and servo control signals. The servo control module 244 may be implemented in any combination of hardware, firmware, or software.

The definition of a disk drive plant can vary somewhat across the industry. Other implementations may include more or fewer modules in the plant 218; however, the general purpose of the plant 218 is to provide the control to the disk(s) 240 and read/write transducer positioning, such that data is accessed at the correct locations on the disk(s). The read/write channel 220 generally communicates data between the device controller 216 and the transducer heads (not shown). The read/write channel may have one or more signal amplifiers that amplify and/or condition data signals communicated to and from the device controller 216.

Generally, accessing the disk(s) 240 is a relatively time-consuming task in the disk drive 202. The time-consuming nature of accessing (i.e., reading and writing) the disk(s) 240 is at least partly due to the electromechanical processes of positioning the disk(s) 240 and positioning the actuator arm. Time latencies that are characteristic of accessing the disk(s) 240 are more or less exhibited by other types of mass storage devices that access mass storage media, such as tape drives, optical storage devices, and the like.

As a result, mass storage devices, such as the disk drive 202, may employ cache memory to facilitate rapid data I/O responses to the host 204. Cache memory, discussed in more detail below, may be used to store pre-fetched data from the disk(s) 240 that will most likely be requested in the near future by the host 204. Cache may also be used to temporarily store data that the host 204 requests to be stored on the disk(s) 240.

The controller 216 on the storage device 202 typically includes I/O processor(s) 222, main processor(s) 224, volatile RAM 228, nonvolatile (NV) RAM 226, and nonvolatile memory 230 (e.g., ROM, flash memory). Volatile RAM 228 provides storage for variables during operation, and may store read cache data that has been pre-fetched from mass storage. NV RAM 226 may be supported by a battery backup (not shown) that preserves data in NV RAM 226 in the event power is lost to controller(s) 216. As such, NV RAM 226 generally stores data that should be maintained in the event of power loss, such as write cache data. Nonvolatile memory 230 may provide storage of computer readable instructions, data structures, program modules and other data for the storage device 202.

Accordingly, the nonvolatile memory 230 includes firmware 232, and a cache management module 234 that manages cache data in the NV RAM 226 and/or the volatile RAM 228. Firmware 232 is generally configured to execute on the processor(s) 224 and support normal storage device 202 operations. Firmware 232 may also be configured to handle various fault scenarios that may arise in the disk drive 202. In the implementation of FIG. 2, the cache management module 234 is configured to execute on the processor(s) 224 to analyze the write cache and to destage write cache data as more fully discussed herein below.

The I/O processor(s) 222 receives data and commands from the host device 204 via the communications channel 206. The I/O processor(s) 222 communicate with the main processor(s) 224 through standard protocols and interrupt procedures to transfer data and commands between NV RAM 226 and the read/write channel 220 for storage of data on the disk(s) 240.

As indicated above, the implementation of a storage device 202 as illustrated by the disk drive 202 in FIG. 2, includes a cache management module 234 and cache memory. The cache management module 234 is configured to perform several tasks during the normal operation of storage device 202. One of the tasks that the cache management module 234 may perform is that of monitoring the ages of cache pages in the write cache. The cache management module 234 may cause any old cache pages to be destaged (i.e., written back to the disk(s) 240). The cache management module 234 may store destage requests in memory associated with any old write cache pages. The destage requests may be used later to trigger a de-staging operation.

De-staging generally includes moving a page or line of data in the write cache to mass storage media, such as one or more disk(s). The size of a page may be any amount of data suitable for a particular implementation. De-staging may also include locking a portion of cache memory to deny access to the portion during the de-staging. The de-staging may be carried out by executable code, executing a de-staging process on the CPU 224.

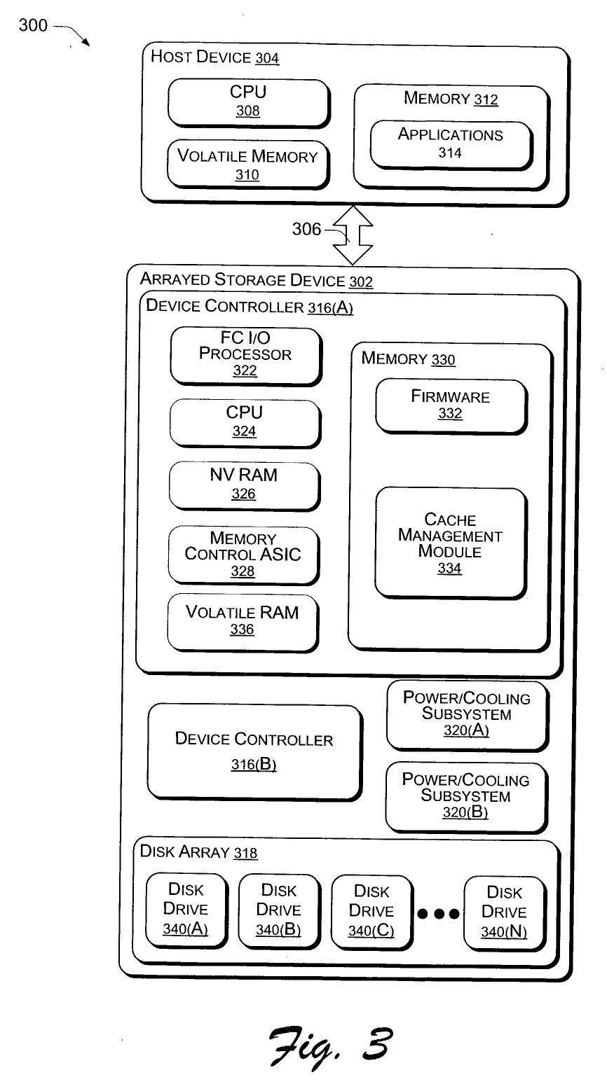

FIG. 2 illustrates an implementation involving a single disk drive 202. An alternative implementation may be a Redundant Array of Independent Disks (RAID), having an array of disk drives and more than one controller. As is discussed below, FIG. 3 illustrates an exemplary RAID implementation.

RAID systems are specific types of virtual storage arrays, and are known in the art. RAID systems are currently implemented, for example, hierarchically or in multi-level arrangements. Hierarchical RAID systems employ two or more different RAID levels that coexist on the same set of disks within an array. Generally, different RAID levels provide different benefits of performance versus storage efficiency.

For example, RAID level 1 provides low storage efficiency because disks are mirrored for data redundancy, while RAID level 5 provides higher storage efficiency by creating and storing parity information on one disk that provides redundancy for data stored on a number of disks. However, RAID level 1 provides faster performance under random data writes than RAID level 5 because RAID level 1 does not require the multiple read operations that are necessary in RAID level 5 for recreating parity information when data is being updated (i.e. written) to a disk.

Hierarchical RAID systems use virtual storage to facilitate the migration (i.e., relocation) of data between different RAID levels within a multi-level array in order to maximize the benefits of performance and storage efficiency that the different RAID levels offer. Therefore, data is migrated to and from a particular location on a disk in a hierarchical RAID array on the basis of which RAID level is operational at that location. In addition, hierarchical RAID systems determine which data to migrate between RAID levels based on which data in the array is the most recently or least recently written or updated data. Data that is written or updated least recently may be migrated to a lower performance, higher storage-efficient RAID level, while data that is written or updated the most recently may be migrated to a higher performance, lower storage-efficient RAID level.

In order to facilitate efficient data I/O, many RAID systems utilize read cache and write cache. The read and write cache of an arrayed storage device is generally analogous to the read and write cache of a disk drive discussed above. Caching in an arrayed storage device, may introduce another layer of caching in addition to the caching that may be performed by the underlying disk drives. In order to take full advantage of the benefits offered by an arrayed storage device, such as speed and redundancy, a cache management system advantageously reduces the likelihood of cache collisions. The implementation discussed with respect to FIG. 3 includes a cache management system for efficient cache page age monitoring and de-staging in an arrayed storage device environment.

FIG. 3 is a functional block diagram illustrating a suitable environment 300 for an implementation including an arrayed storage device 302 in accordance with the system environment 100 of FIG. 1. “Arrayed storage device” 302 and its variations, such as “storage array device”, “array”, “virtual array” and the like, are used throughout this disclosure to refer to a plurality of storage components/devices being operatively coupled for the general purpose of increasing storage performance. The arrayed storage device 302 of FIG. 3 is embodied as a virtual RAID (redundant array of independent disks) device. A host device 304 is embodied generally as a computer such as a personal computer (PC), a laptop computer, a server, a Web server, a handheld device (e.g., a Personal Digital Assistant or cellular phone), or any other computer device that may be configured to communicate with RAID device 302.

The host device 304 typically includes a processor 308, a volatile memory 316 (i.e., RAM), and a nonvolatile memory 312 (e.g., ROM, hard disk, floppy disk, CD-ROM, etc.). Nonvolatile memory 312 generally provides storage of computer readable instructions, data structures, program modules and other data for host device 304. The host device 304 may implement various application programs 314 stored in memory 312 and executed on processor 308 that create or otherwise access data to be transferred via network connection 306 to the RAID device 302 for storage and subsequent retrieval.

The applications 314 might include software programs implementing, for example, word processors, spread sheets, browsers, multimedia players, illustrators, computer-aided design tools and the like. Thus, the host device 304 provides a regular flow of data I/O requests to be serviced by virtual RAID device 302.

RAID devices 302 are generally designed to provide continuous data storage and data retrieval for computer devices such as the host device(s) 304, and to do so regardless of various fault conditions that may occur. Thus, a RAID device 302 typically includes redundant subsystems such as controllers 316(A) and 316(B) and power and cooling subsystems 320(A) and 320(B) that permit continued access to the disk array 302 even during a failure of one of the subsystems. In addition, RAID device 302 typically provides hot-swapping capability for array components (i.e. the ability to remove and replace components while the disk array 318 remains online) such as controllers 316(A) and 316(B), power/cooling subsystems 320(A) and 320(B), and disk drives 340 in the disk array 318.

Controllers 316(A) and 316(B) on RAID device 302 mirror each other and are generally configured to redundantly store and access data on disk drives 340. Thus, controllers 316(A) and 316(B) perform tasks such as attaching validation tags to data before saving it to disk drives 340 and checking the tags to ensure data from a disk drive 340 is correct before sending it back to host device 304. Controllers 316(A) and 316(B) also tolerate faults such as disk drive 340 failures by recreating data that may be lost during such failures.

Controllers 316 on RAID device 302 typically include I/O processor(s) such as FC (fiber channel) I/O processor(s) 322, main processor(s) 324, volatile RAM 336, nonvolatile (NV) RAM 326, nonvolatile memory 330 (e.g., ROM, flash memory), and one or more application specific integrated circuits (ASICs), such as memory control ASIC 328. Volatile RAM 336 provides storage for variables during operation, and may store read cache data that has been pre-fetched from mass storage. NV RAM 326 is typically supported by a battery backup (not shown) that preserves data in NV RAM 326 in the event power is lost to controller(s) 316. NV RAM 326 generally stores data that should be maintained in the event of power loss, such as write cache data. Nonvolatile memory 330 generally provides storage of computer readable instructions, data structures, program modules and other data for RAID device 302.

Accordingly, nonvolatile memory 330 includes firmware 332, and a cache management module 334 operable to manage cache data in the NV RAM 326 and/or the volatile RAM 336. Firmware 332 is generally configured to execute on processor(s) 324 and support normal arrayed storage device 302 operations. In one implementation the firmware 332 includes array management algorithm(s) to make the internal complexity of the array 318 transparent to the host 304, map virtual disk block addresses to member disk block addresses so that I/O operations are properly targeted to physical storage, translate each I/O request to a virtual disk into one or more I/O requests to underlying member disk drives, and handle errors to meet data performance/reliability goals, including data regeneration, if necessary. In the current implementation of FIG. 3, the cache management module 334 is configured to execute on the processor(s) 324 and analyze data in the write cache to destage write cache pages that are older than a predetermined age.

The FC I/O processor(s) 322 receives data and commands from host device 304 via the network connection 306. FC I/O processor(s) 322 communicate with the main processor(s) 324 through standard protocols and interrupt procedures to transfer data and commands to redundant controller 316(B) and generally move data between volatile RAM 336, NV RAM 326 and various disk drives 340 in the disk array 318 to ensure that data is stored redundantly. The arrayed storage device 302 includes one or more communications channels to the disk array 318, whereby data is communicated to and from the disk drives 340. The disk drives 340 may be arranged in any configuration as may be known in the art. Thus, any number of disk drives 340 in the disk array 318 can be grouped together to form disk systems.

The memory control ASIC 328 generally controls data storage and retrieval, data manipulation, redundancy management, and the like through communications between mirrored controllers 316(A) and 316(B). Memory controller ASIC 328 handles tagging of data sectors being striped to disk drives 340 in the array of disks 318 and writes parity information across the disk drives 340. In general, the functions performed by ASIC 328 might also be performed by firmware or software executing on general purpose microprocessors. Data striping and parity checking are well-known to those skilled in the art.

The memory control ASIC 328 also typically includes internal buffers (not shown) that facilitate testing of memory 330 to ensure that all regions of mirrored memory (i.e. between mirrored controllers 316(A) and 316(B)) are compared to be identical and checked for ECC (error checking and correction) errors on a regular basis. The memory control ASIC 328 notifies the processor 324 of these and other errors it detects. Firmware 332 is configured to manage errors detected by memory control ASIC 328 in a tolerant manner which may include, for example, preventing the corruption of array 302 data or working around a detected error/fault through a redundant subsystem to prevent the array 302 from crashing.

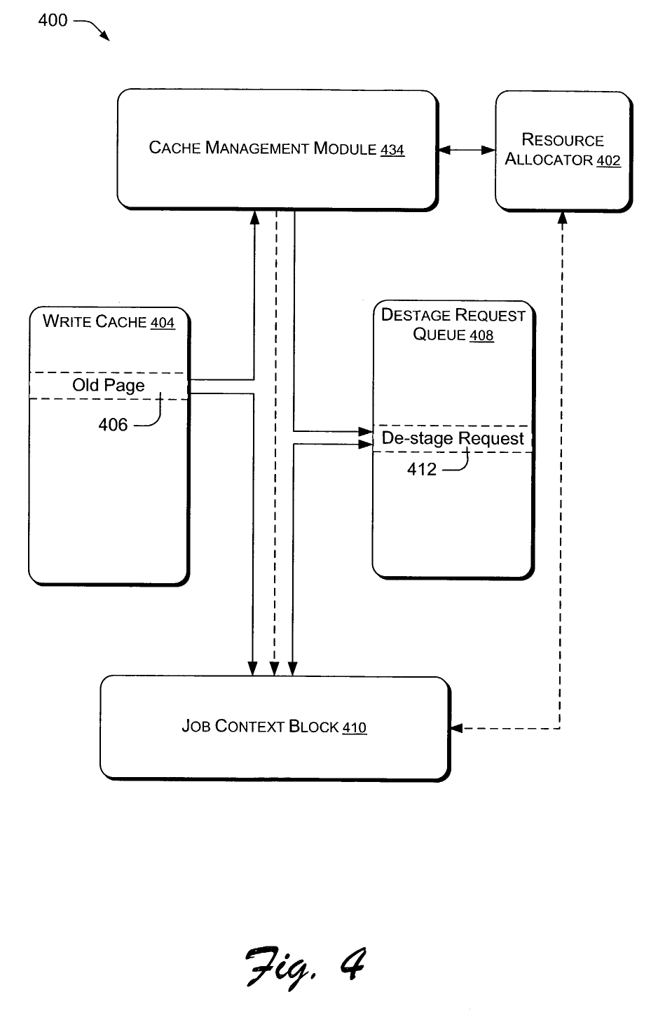

FIG. 4 illustrates an exemplary functional block diagram 400 that may reside in the system environments of FIGS. 1-3, wherein a cache management module 434 communicates with a resource allocation module 402 in order to manage de-staging of old page(s) 406 in a write cache 404. The cache management module 434 is in operable communication with the resource allocation module 402, the write cache 404, a destage request queue 408, and a job context block (JCB) 410.

In one implementation, the cache management module 434 identifies old pages 406 in the write cache 404 and requests a JCB 410 from the resource allocation module 402 to perform a destage operation on the old page 406. If a JCB 410 is available (i.e., free for use), the resource allocation module 402 refers the cache management module 434 to the available JCB 410. If no JCBs are available when the cache management module 434 requests a JCB, the resource allocation module 402 may notify the cache management module 434 that no JCBs are available.

In a particular implementation, upon such notification of non-availability, the cache management module 434 may put a destage request 412 in the destage request queue 408. Later, if the JCB 410 becomes available, the resource allocation module 402 may notify the cache management module 434 that the JCB 410 is available for use. The cache management module 434 may then start a de-staging process with the old page 406 associated with the destage request 412 using the available JCB 410.

In an exemplary implementation, the cache management module 434 may execute a periodic cache aging (PCA) algorithm that substantially periodically (for example, every 4 seconds) analyzes the age of cache pages in the write cache 404. In one implementation of the PCA algorithm, the PCA algorithm checks a “dirty” flag associated with each of the pages in the write cache 404. The dirty flag may be a bit or set of bits in memory that is set to a particular value when the associated page is changed. If the dirty flag is set to the particular value, the page is not considered an old page, because the page has changed at some time during the previous period. If the dirty flag is not set to the particular value, the associated page is an old page, and should be destaged.

The cache management module 434 prepares to destage old pages that are identified, such as the old page 406. In one implementation, the cache management module 434 calls the resource allocation module 402 to request input/output (I/O) resource(s) for performing a de-staging operation. The resource allocation module 402 may be implemented in hardware, software, or firmware (for example, the firmware 232, FIG. 2, or the firmware 332, FIG. 3). The resource allocation module 402 generally responds to requests from various storage device processes or modules for input/output (I/O) resource(s) and assigns available JCBs 410 to handle the requests.

In one implementation, the JCB 410 includes a block of memory (e.g., RAM) to keep track of the context of a thread, process, or job. The JCB 410 may contain data regarding the status of CPU registers, memory locks, read/write channel bandwidth, memory addresses, and the like, which may be necessary for carrying out tasks in the storage device, such as a page de-staging operation. The JCB 410 may also include control flow information to track and/or change which module or function that has control over the job. In one implementation, the resource allocation module 402 monitors JCBs 410 in the system and refers requesting modules to available JCBs 410.

If an available JCB 410 exists when the cache management module 434 requests a JCB from the resource allocation module 402, the resource allocation module 402 may notify the cache management module 434 of the available JCB 410. In one implementation, the resource allocation module 402 refers the cache management module 434 to the available JCB 410 by communicating a JCB 410 memory pointer to the cache management module 434. The memory pointer references the available JCB 410 and may be used by the cache management module to start de-staging the old page 406.

If no JCBs 410 are available, the resource allocation module 402 may notify the cache management module 434 that no JCBs are currently available. One way the resource allocation module 402 can notify the cache management module 434 that no JCBs are available is by not immediately responding to the call from the cache management module 434. Another way the resource allocation module 402 can notify the cache management module 434 that no JCBs are available is for the resource allocation module 402 to communicate a predetermined “non-availability” flag to the cache management module 434, which indicates that no JCBs are available.

If no JCBs are currently available, in one implementation the resource allocation module 402 saves a JCB request corresponding to the cache management module 434 request. The JCB request serves as a reminder to notify the cache management module 434 when a JCB becomes available. The resource allocation module 402 may place JCB requests on a queue (not shown) to be serviced when JCBs become available. The resource allocation module 402 may prioritize JCB requests in the queue in any manner suitable for the particular implementation. For example, JCB requests associated with host read requests may be given a higher priority than JCB requests associated with de-staging operations, in order to prevent delayed response to host read requests.

In a particular implementation, the cache management module 434 communicates context information or state information to the available JCB 410. The context information includes data that correspond(s) to a de-staging operation for the old page 406. By way of example, and not limitation, the context information may include a beginning memory address and an ending memory address of the old page 406 in the write cache 404. The context information may also include logical unit (LUN) and/or logical block address (LBA) information associated with the old page 406, to facilitate the de-staging operation.

The cache management module 434 is in communication with the destage request queue 408. The destage request queue 408 is generally a processor-readable (and writable) data structure in memory (for example, RAM 226, FIG. 2, RAM 326, FIG. 3, memory 230, FIG. 2, or memory 330, FIG. 3). The destage request queue 408 can receive and hold queued data, such as data structures or variable data. The queued data items in the destage request queue 408 are interrelated with each other in one or more ways.

One way the data items in the exemplary queue 408 may be interrelated is the order in which data items are put into and/or taken off the queue 408. Any ordering or prioritizing scheme as may be known in the art may be employed with respect to adding and removing data items from the queue 408. In a particular implementation of the queue 408, a first-in-first-out (FIFO) scheme is employed. In another exemplary implementation of the queue 408, a last-in-first-out (LIFO) scheme is employed. Other queuing schemes consistent with implementations described herein will be readily apparent to those skilled in the art.

The cache management module 434 may place a destage request 412 onto the destage request queue 408. The destage request 412 may be a data structure that has data corresponding to the old write page 406, such as, but not limited to, the start and end addresses of the old page 406, an associated LBA, an associated LUN, and/or an address in NVRAM where the data resides.

In one implementation, the cache management module 434 places only up to a maximum, or threshold, number of destage requests 412 on the queue 408, regardless of whether any other old pages 406 reside in the write cache 404. In this implementation, not all the old pages 406 will be locked, only those pages that are either currently being destaged (i.e., those pages for which a JCB is available) and the pages for which a destage request has been placed on the queue 408. Thus, any other old pages are not locked and may still be used to cache data written from the host. As a result, the likelihood of a cache collision may be substantially reduced as compared to another implementation wherein all the old pages in the cache are locked while awaiting a JCB.

In one implementation, the maximum, or threshold, number of allowable destage entries that may be placed on the queue 408 is set such that a busy system always has a few destage requests on the queue 408, but small enough such that only a small number of cache pages are locked, waiting on the destage queue 408. Keeping several requests on the queue 408 allows for a substantially continuous flow of write cache pages from the write cache 404 to the mass storage media because a destage request will be waiting any time a JCB is made available to the cache management module 434. Thus, the cache management module 434 does not have to do any additional work to prepare the old page for destage operation.

Sometime after the cache management module 434 puts the destage request 412 on the queue 408, such as when a JCB becomes available, the cache management module 434 may access the destage request 412 in order to destage the old page 406 that corresponds to the destage request 412.

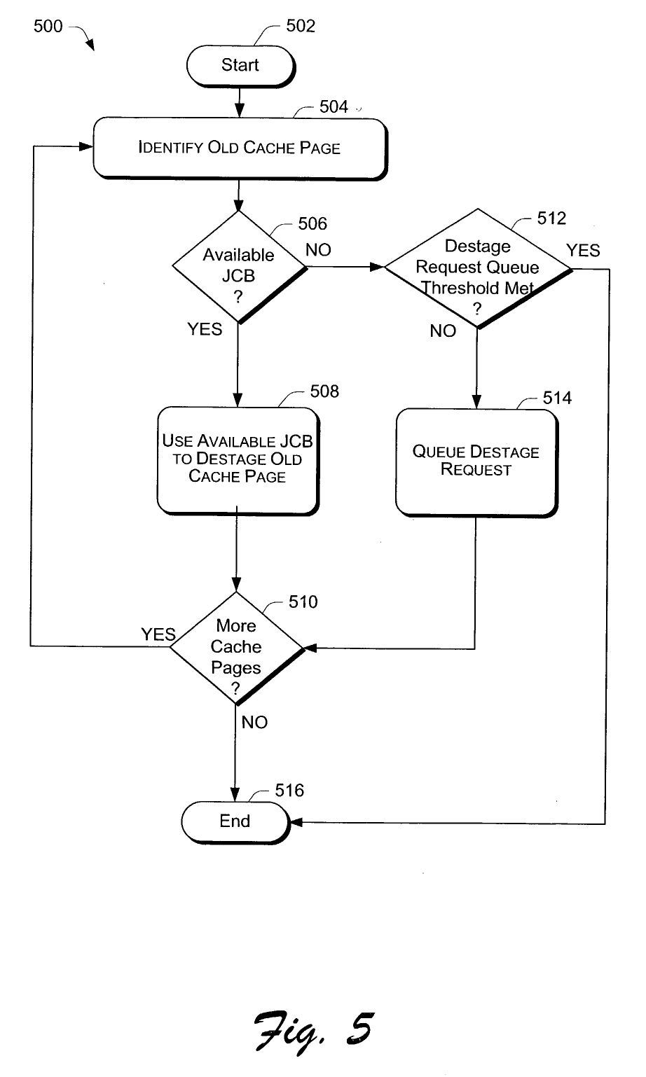

FIG. 5 illustrates an operational flow 500 having exemplary operations that may be executed in the systems of FIGS. 1-4 for managing write cache such that cache collisions are minimized or prevented. In general, the operation flow 500 identifies old cache pages in a write cache, if any exist, that should be destaged, uses any available JCBs to perform the de-staging of the old cache pages, and queues a maximum number of destage requests corresponding to old pages for which JCBs are not currently available. The operational flow 500 may be executed in any computer device, such as the storage systems of FIGS. 1-4.

After a start operation 502, an identify operation 504 identifies one or more old cache pages in the write cache. In one implementation, the identify operation analyzes each page in the write cache and determines whether any data in the page has changed within a predetermined time. If the page has changed within the predetermined time, the page is not old; however, if data in the page has not changed within the predetermined time, the page is an old page. For example, the identify operation 504 may determine whether a page has been modified during a prescribed amount of time, such as 2 seconds. The identify operation 504 may determine that a page has been changed by checking a “dirty” flag associated with the page that is updated in memory whenever the page is changed.

Assuming an old cache page is identified by the identify operation 504, a first query operation 506 determines if a job context block (JCB) is available for de-staging the identified old cache page. In one implementation, the query operation 506 involves requesting a JCB from a resource allocation module (for example, the resource allocation module 402, FIG. 4). The resource allocation module responds to the request with either a reference to an available JCB or an indication that no JCBs are currently available.

If a JCB is currently available, the operation flow 500 branches “YES” to a use operation 508. The use operation uses the available JCB to perform a destage operation 508. In one implementation, the use operation 508 sends context or state information to the available JCB. The context information may include beginning and ending memory addresses associated with the identified old page (i.e., identified in the identify operation 504), a logical unit (LUN), a logical block address (LBA), an address in NVRAM where the data resides, or any other data to facilitate de-staging the identified old page.

The use operation 508 may involve starting a destage process or job within the storage device. The destage process may be, for example, a thread executed within an operating system or an interrupt driven process that periodically executes until the identified old page is completely written back to a disk. The use operation 508 may assign a priority to the destage process relative to other processes that are running in the storage device. In addition, the use operation 508 may cause the identified old page to be locked, whereby the page is temporarily accessible only to the destage process while the page is being written to disk memory.

A second query operation 510 determines if more pages are in write cache to be analyzed with regard to age. In one implementation, a write page counter is incremented in the second query operation 510. The second query operation 510 may compare the write page counter to a total number of write pages in the write cache to determine whether any more write cache pages are to be analyzed. If any more write cache pages are to be analyzed, the operation flow 500 branches “YES” back to the identify operation 504. If the query operation 510 determines that no more write cache pages are to be analyzed, the operation flow 500 branches “NO” to an end operation 516.

If, in the first query operation 506, it is determined that no JCBs are currently available to for de-staging the identified old page, the operation flow 500 branches “NO” to a third query operation 512. The third query operation 512 determines whether a threshold number of destage requests have been placed on a destage request queue (for example, the destage request queue 408, FIG. 4). The threshold number associated with the destage request queue may be a value stored in memory, for example, during manufacture or startup of the storage device. Alternatively, the threshold number of allowed destage requests could be varied automatically in response to system performance parameters. The value of the threshold number is implementation specific, and therefore may vary from one storage device to another, depending on desired performance levels.

In one implementation of the third query operation 512, the threshold number is compared to a destage request counter representing the number of destage requests in the destage request queue. If the number of requests in the destage request queue is greater than or equal to the threshold number, the third query operation 512 enables the write cache page to be used for satisfying host write requests, even though the write cache page is an old cache page. Thus, if a JCB is not available and a destage request cannot be queued, the third query operation 512 prevents the write cache page from being locked. If a destage request cannot be queued, the operation flow 500 branches “YES” to the end operation 516.

If, on the other hand, the number of requests in the destage request queue is less than the threshold number, the operation flow branches “NO” to a queue operation 514. The queue operation 514 stores a destage request on the destage request queue. In one implementation, the queue operation creates a destage request. The destage request may include various data related to the corresponding old page in write cache, such as, but not limited to, beginning address, ending address, LUN, and/or LBA. The destage request may be put on the destage request queue according to a priority or no level of priority. For example, the destage request queue may be a first-in-first-out (FIFO) queue, a last-in-first-out (LIFO) queue, or destage requests associated with older pages may be given a higher priority. The queue operation 514 may also increment the destage request counter.

From the queue operation 514, the operation flow 500 enters the second query operation 510 where it is determined whether more write cache pages are to be checked for age. If no more write cache pages are to be analyzed, the operation flow branches “NO” to the end operation where the operation flow ends.

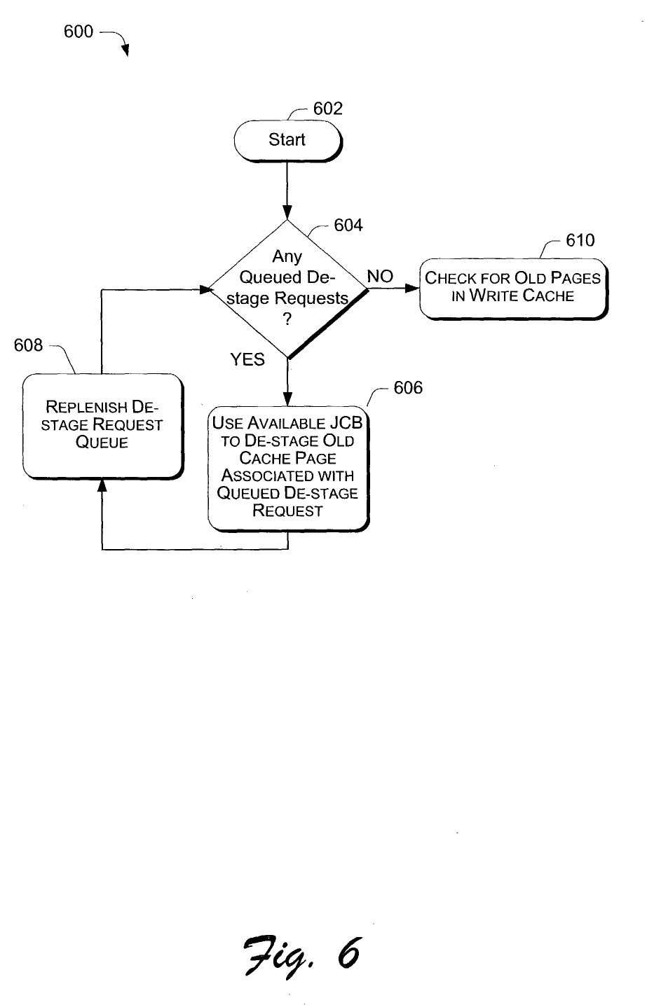

FIG. 6 illustrates an operational flow 600 having exemplary operations that may be executed in the systems of FIGS. 1-3 for managing cache such that cache collisions are minimized. In general, the operation flow 600 prepares old pages that correspond to queued destage requests for de-staging, and replenishes the destage request queue with additional requests. The operation flow 600 uses an available JCB to destage an old write cache page associated with a queued destage request, if any, and if no destage requests are queued, the operation flow analyzes the write cache to identify old pages in the write cache (for example, with the operation flow 500, FIG. 5).

More specifically, after a start operation 602, the operation flow 600 enters a query operation 604. The query operation 604 determines whether any destage requests exist. In a particular implementation, the query operation 604 checks a destage request counter representing the number of destage requests on a destage request queue (for example, the destage request queue 408, FIG. 4). If the destage request counter is greater than zero, then it is determined that a destage request has been queued and an old write cache page exists in write cache memory that should be destaged; the operation flow 600 branches “YES” to a use operation 606.

Assuming a JCB is available, the use operation 606 uses the available JCB to destage the old page associated with the destage request identified in the query operation 604. In one implementation, the use operation 606 creates context information associated with the old page and passes the context information to the available JCB. As discussed, the context information uniquely identifies the old page to be destaged. The use operation 606 may create a destage process associated with the old page, prioritize the destage process, and start the destage process executing.

After the available JCB is used to destage a queued destage request, a replenish operation 608 replenishes the destage request queue. In this implementation, the queue is populated with destage requests up to the threshold in order to keep the queue depth substantially constant at the threshold. The replenish operation 608 may perform an aging algorithm on the data in the write cache to determine which old pages should be queued for de-staging.

Alternatively, the replenish operation 608 may populate the queue with destage requests associated with write cache pages that were previously determined to be old, but were neither destaged because no JCBs were available, nor queued because the destage request queue had met the threshold. In this implementation, an old page data structure may be maintained and updated to point to the oldest pages in the write cache at the time their age is determined. The data structure may contain pointers to old write cache pages that have not yet been queued for de-staging. In this implementation, the pages pointed to by the old page data structure are not locked until a destage request has been placed on the destage request queue.

After the replenish operation 608, the query operation 604 again determines whether any destage requests reside in the destage request queue. If, in the query operation 604, it is determined that no destage requests exist on the destage request queue, the operation flow 600 branches “NO” to a check operation 610. The check operation 610 checks the pages in the write cache to determine if any of the write cache pages are old pages (i.e., older than a predetermined age). In one implementation, the check operation 610 branches to the operation flow 500 shown in FIG. 5.

Although the description above uses language that is specific to structural features and/or methodological acts, it is to be understood that the subject matter of the appended claims is not limited to the specific features or acts described. Rather, the specific features and acts are disclosed as exemplary forms of implementation. In addition, the exemplary operations described above are not limited to the particular order of operation described, but rather may be executed in another order or orders and still achieve the same results described.

We claim:

1. A processor-readable medium comprising processor-executable instructions configured for executing a method comprising:
determining whether a cache page exceeds a predetermined age; and
if the cache page exceeds the predetermined age, locking the cache page and queuing a destage request on a destage request queue unless the number of destage requests on the destage request queue exceeds a predetermined number,
wherein when the destage request queue exceeds the predetermined number the cache page is unlocked and available to satisfy requests.

2. A processor-readable medium as recited in claim 1, wherein the method further comprises:
if the cache page exceeds the predetermined age,
determining whether input/output resources are available to destage the cache page, and
if input/output resources are available, using the available input/output resources to destage the cache page.

3. A processor-readable medium as recited in claim 1, wherein the method further comprises:
if the cache page exceeds the predetermined age,
determining whether input/output resources are available to destage the cache page, and
if input/output resources are not available, queuing an input/output resource request to use input/output resources when they become available to destage the cache page.

4. A processor-readable medium as recited in claim 2, wherein the determining whether input/output resources are available comprises:
requesting input/output resources from a resource allocation module; and
receiving a notification indicating either that input/output resources are available or that input/output resources are not available.

5. A processor-readable medium as recited in claim 1, the method further comprising:
if the cache page exceeds the predetermined age,
determining whether input/output resources are available to destage the cache page,
if input/output resources are available, identifying a destage request on the destage request queue associated with a cache page,
destaging the cache page associated with the identified destage request, and
queuing another destage request on the destage request queue associated with another cache page that exceeds the predetermined age.

6. A processor-readable medium as recited in claim 1, wherein the method further comprises:
if the cache page exceeds the predetermined age,
determining whether the number of destage requests on the destage request queue exceeds the predetermined number, and
if the number of destage requests on the destage request queue does not exceed the predetermined number, enabling the cache page to be used for satisfying requests.

7. A processor-readable medium as recited in claim 6, wherein the enabling the cache page to be used comprises:
unlocking the cache page.

8. A processor-readable medium comprising processor-executable instructions configured for executing a method comprising:
determining whether a cache page exceeds a predetermined age;
if the cache page exceeds the predetermined age, locking and destaging the cache page unless destaging resources are unavailable; and
if the cache page exceeds the predetermined age and destaging resources are not available, locking the cache page and queuing a destage request on a destage request queue unless the number of destage requests on the destage request queue exceeds a predetermined number,
wherein when the destage request queue exceeds the predetermined number, the cache page is unlocked and available to satisfy requests.

9. A processor-readable medium as recited in claim 8, wherein the method further comprises:
requesting destage resources for each of a plurality of destage requests on the destage request queue; and
prioritizing each of the destage requests on the destage request queue according to age.

10. A processor-readable medium as recited in claim 9, wherein the destage resources comprise job context blocks operable to store context information related to a destaging operation.

11. A processor-readable medium as recited in claim 9, wherein the method further comprises:
placing a destage resource request on a resource request queue; and
prioritizing the destage resource request on the resource request queue.

12. A method of managing cache memory in a data storage device comprising:
determining whether a page in write cache memory is older than a predetermined age;
determining whether a destage request queue has a threshold number of destage requests;
if the page is older than a predetermined age, and the destage request queue does not have the threshold number of destage requests, locking the page and queuing a destage request corresponding to the page; and
if the page is older than a predetermined age, and the destage request queue has the threshold number of destage requests, enabling use of the page for write caching operations in response to write requests.

13. A method as recited in claim 12, further comprising:
determining whether input/output resources are available; and
if the page is older than the predetermined age and if the input/output resources are available, assigning the input/output resources to a destaging process operable to destage the page.

14. A method as recited in claim 13, wherein the assigning the input/output resources comprises:
storing context information related to the destaging process in a job context block.

15. A method as recited in claim 14, further comprising:
prioritizing the de-staging process among other processes in the storage device.

16. A method as recited in claim 14, wherein the context information comprises:
a starting address of the page in nonvolatile random access memory;
an ending address of the page in nonvolatile random access memory;
a logical block address (LBA) corresponding to the page; and
a logical unit (LUN) corresponding to the page.

17. A method as recited in claim 12, wherein the using the page comprises:
permitting access to the page to satisfy a host write request, regardless of the age of the page.

18. A method as recited in claim 16, further comprising:
determining if a job context block is available; and
if a job context block is available, using the job context block to destage the page corresponding to the destage request on the destage request queue.

19. A method as recited in claim 16, further comprising:
placing another destage request on the destage request queue, corresponding to another page that is older than the predetermined age.

20. A method as recited in claim 12, wherein the determining whether a page is older than a predetermined age is performed substantially periodically.

21. A method as recited in claim 13, wherein the determining whether a job context block is available comprises:
placing a job context block request on a job context block request queue; and
prioritizing the job context block request among other job context block requests.

22. A storage device comprising:
a mass storage medium;
a cache memory in operable communication with the mass storage medium; and
a cache management module operable to identify a cache page that exceeds a predetermined age, and lock and destage the cache page if destaging resources are available and, if destaging resources are not available, lock the cache page and queue a destage request on a destage request queue if fewer than a predetermined number of destage requests are on the destage request queue, and, if fewer than a predetermined number of destage requests are on the destage request queue, enable the cache page to satisfy requests.

23. A storage device as recited in claim 22, further comprising:
a resource allocation module in operable communication with the cache management module, operable to allocate available input/output resources to the cache management module.

24. A storage device as recited in claim 22, wherein the storage device is an array of storage devices.

25. A storage device as recited in claim 24, wherein the array of storage devices comprises at least one of:
magnetic disks;
tapes;
optical disks; or
solid state disks.

26. A storage device as recited in claim 22 wherein the cache management module is further operable to store context information in a job context block, the context information comprising data related to a destage process to destage the cache page.

27. A storage device as recited in claim 22 wherein the cache management module is operable to create a data structure used to perform a destage operation on the cache page, the data structure comprising:
a starting address of the old page in write cache memory;
an ending address of the old cache page in write cache memory;
a logical block address associated with the old cache page; and
a logical unit associated with the old cache page.

28. A system comprising:
a mass storage media;
a cache in operable communication with the mass storage media and having a write cache, wherein data in the write cache may be destaged to the mass storage media; and
means for identifying write cache data having an age greater than a predetermined age and allowing the write cache data to be used for host write “requests if input/output resources are unavailable to destage the write cache page and if a destage request queue has more than a predetermined number of destage requests.

29. A system as recited in claim 28 wherein the means for identifying comprises:
a cache management module operable to determine an age of data in the write cache; and
a resource allocation module in operable communication with the cache management module operable to receive a request for input/output resources and allocate available input/output resources to destage write cache data having an age greater than the predetermined age.

30. A system as recited in claim 28 wherein the means for identifying comprises:
a cache management module operable to determine an age of data in the write cache;
a resource allocation module in operable communication with the cache management module, operable to receive a request for input/output resources and allocate available input/output resources to destage write cache data having an age greater than the predetermined age; and
a destage request queue operable to store a destage request from the cache management module if no input/output resources are available to destage the write cache data.

31. A system as recited in claim 28 wherein the means for identifying comprises:
a resource allocation module operable to receive a input/output resource request to destage write cache data having an age greater than the predetermined age and queue the input/output resource request if input/output resources are unavailable;
a destage request queue operable to store a destage request associated with the write cache data if no input/output resources are available to destage the write cache data; and
a cache management module operable to prevent locking of addresses associated with the write cache data if no input/output resources are available from the resource allocation module, and if the destage request cannot be stored on the destage request queue.
